(19) United States
(12) Patent Application Publication
(10) Pub. No.: US 2013/0013506 A1
(43) Pub. Date: Jan. 10, 2013

(54) Variable Service Fee For Overdraft Protection

(75) Inventors: Ronald Wiggins, Helena, AL (US); Joshua Sloan Adams, Pinson, AL (US)

(73) Assignee: INSIGHT, LLC, Birmingham, AL (US)

(21) Appl. No.: 13/436,589

(22) Filed: Mar. 30, 2012

Related U.S. Application Data
(60) Provisional application No. 61/470,900, filed on Apr. 1, 2011.

(51) Int. Cl. G06Q 20/40

(52) U.S. Cl. 705/44

(57) ABSTRACT

Systems and methods provide variable service fees for protection against overdraft of resources. The resources can be monetary or non-monetary and generally are associated with a service. Protection against overdraft relies at least on authorization of a request for an OD transaction, the request having one or more data indicative of a service transaction that triggers an overdraft condition leading to such request. Authorization or denial of such request is based on one or more rules applicable to the one or more data. For an authorized OD transaction, and based on at least one rule of the one or more rules, a variable service fee is assessed to an overdraft account linked to the overdraft transaction. Assessment of such fee affords protection against overdraft, which allows utilization of resources even in scenarios a resource allocation is exhausted.

### CROSS-REFERENCE TO RELATED APPLICATION

This application relates to and claims the benefit of U.S. Provisional Patent Application No. 61/470,900, filed on Apr. 1, 2011, which is incorporated herein by reference in its entirety.

### SUMMARY

The subject disclosure relates to implementation of variable service fees for protection against overdraft of resources. The resources can be monetary or non-monetary and generally are associated with a service. Protection against overdraft relies at least on authorization of a request for an OD transaction, the request having one or more data indicative of a service transaction that triggers an overdraft condition leading to such request. Authorization or denial of such request is based on one or more rules applicable to the one or more data. For an authorized OD transaction, and based on at least one rule of the one or more rules, a variable service fee is assessed to an overdraft account linked to the overdraft transaction. Assessment of such fee affords protection against overdraft, which allows utilization of resources even in scenarios a resource allocation is exhausted. The one or more rules can be adjusted autonomously.

In an aspect, the subject disclosure provides a method comprising receiving a request for an overdraft transaction, the request for the overdraft transaction having a one or more data indicative of a commercial transaction causing the request for the overdraft transaction. The method also can comprise authorizing or denying the request for the overdraft transaction based at least on a set of rules applicable to the one or more data. Moreover, the method can comprise, in response to authorizing the overdraft transaction, assessing a variable overdraft fee to an overdraft account linked to the overdraft transaction, wherein the assessing is based on at least one rule of the set of the rules applicable to the one or more data.

In another aspect, a system is provided. The system comprises a memory that retains data and computer-executable instructions; and a processor functionally coupled to the memory and programmed by the computer-executable instructions to receive a request for an overdraft transaction, the request for the overdraft transaction having one or more data indicative of a commercial transaction causing the request for the overdraft transaction. The processor also is programmed by the computer-executable instructions to authorize or deny the request for the overdraft transaction based at least on a set of rules applicable to the one or more data. In addition, the processor is programmed by the computer-executable instructions to assess a variable overdraft fee to an overdraft account linked to the overdraft transaction for an authorized overdraft transaction; assessment of the variable overdraft fee is based on at least one rule of the set of the rules applicable to the one or more data.

In yet another aspect, the subject disclosure provides a computer program product comprising a computer-readable storage medium encoded with computer-executable instructions comprising: a first set of computer-executable instructions that, in response to execution, cause a processor to receive a request for an overdraft transaction, the request for the overdraft transaction having one or more data indicative of a commercial transaction causing the request for the overdraft transaction; a second set of computer-executable instructions that, in response to execution, cause the processor to authorize or deny the request for the overdraft transaction based at least on a set of rules applicable to the one or more data; and a third set of computer-executable instructions that, in response to execution, cause the processor to assess a variable overdraft fee to an overdraft account linked to the overdraft transaction for an authorized overdraft transaction.

Additional aspects, features, or advantages of the subject disclosure will be set forth in part in the description which follows, and in part will be obvious from the description, or may be learned by practice of the subject disclosure. The advantages of the subject disclosure will be realized and attained by means of the elements and combinations particularly pointed out in the appended claims. It is to be understood that both the foregoing general description and the following detailed description are exemplary and explanatory only and are not restrictive of the subject disclosure.

### BRIEF DESCRIPTION OF THE DRAWINGS

The accompanying drawings are incorporated and illustrate exemplary embodiment(s) of the subject disclosure and together with the description and claims appended hereto serve to explain various principles, features, or aspects of the subject disclosure.

FIG. 1 illustrates an exemplary system that provides variable service fee for overdraft protection in accordance with aspects of the subject disclosure.

FIG. 2 illustrates an exemplary embodiment of a decision engine in accordance with aspects described herein. The illustrated decision engine can be part of the exemplary system presented in FIG. 1.

FIG. 3 illustrates an example system that enables autonomous generation of the set of rules in accordance with aspects described herein.

FIG. 4 illustrates an exemplary method for implementing variable overdraft fees in accordance with aspects of the subject disclosure.

FIG. 5 illustrates an exemplary method for adjusting at least one rule of a set of rules that determines outcome of an overdraft cycle in accordance with aspects of the subject disclosure.

FIG. 6 illustrates a computing environment that enables various aspects of implementation of variable service fees for overdraft protection in accordance with aspects described herein.

### DETAILED DESCRIPTION

The subject disclosure may be understood more readily by reference to the following detailed description of exemplary embodiments of the subject disclosure and to the Figures and their previous and following description.

Before the present compounds, compositions, articles, devices, and/or methods are disclosed and described, it is to be understood that the subject disclosure is not limited to specific systems and methods for implementation of a variable service fee for overdraft protection. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

In the subject specification and in the claims which follow, reference may be made to a number of terms which shall be defined to have the following meanings:

“Optional” or “optionally” means that the subsequently described event or circumstance may or may not occur, and that the description includes instances where said event or circumstance occurs and instances where it does not.

As employed in this specification and annexed drawings, the terms “unit,” “component,” “interface,” “engine,” “system,” “platform,” and the like are intended to include a computer-related entity or an entity related to an operational apparatus with one or more specific functionalities, wherein the computer-related entity or the entity related to the operational apparatus can be either hardware, a combination of hardware and software, software, or software in execution. One or more of such entities are also referred to as “functional elements.” As an example, a unit may be, but is not limited to being, a process running on a processor, a processor, an object, an executable computer program, a thread of execution, a program, a memory (e.g., a hard disc drive), and/or a computer. As another example, a unit can be an apparatus with specific functionality provided by mechanical parts operated by electric or electronic circuitry which is operated by a software or a firmware application executed by a processor, wherein the processor can be internal or external to the apparatus and executes at least a part of the software or firmware application. In addition or in the alternative, a unit can provide specific functionality based on physical structure or specific arrangement of hardware elements. As yet another example, a unit can be an apparatus that provides specific functionality through electronic functional elements without mechanical parts, the electronic functional elements can include a processor therein to execute software or firmware that provides at least in part the functionality of the electronic functional elements. An illustration of such apparatus can be control circuitry, such as a programmable logic controller. The foregoing example and related illustrations are but a few examples and are not intended to be limiting. Moreover, while such illustrations are presented for a unit, the foregoing examples also apply to a component, an engine, a system, a platform, and the like. It is noted that in certain embodiments, or in connection with certain aspects or features thereof, the terms “unit,” “component,” “system,” “interface,” “engine,” “platform” can be utilized interchangeably. It should be appreciated that one or more functional elements of the disclosure can be implemented (e.g., performed) by software, hardware, or a combination of software and hardware.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Reference will now be made in detail to the various embodiment(s), aspects, and features of the subject disclosure, example(s) of which are illustrated in the accompanying drawings. Wherever possible, the same reference numbers are used throughout the drawings to refer to the same or like parts.

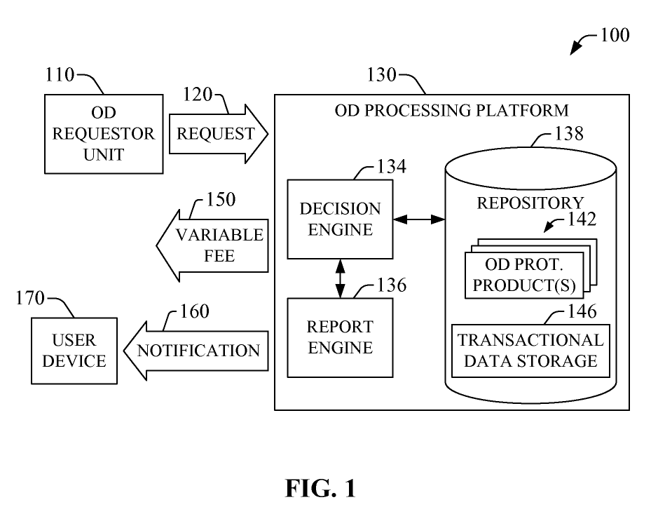

Referring to the drawings, FIG. 1 illustrates a high-level block diagram of an exemplary system 100 that provides a variable service fee for overdraft protection in accordance with aspects of the subject disclosure. The variable service fee also is referred to as variable overdraft fee; such terms are employed interchangeably in the subject disclosure. The variable service fee is part of an overdraft protection product that affords overdraft protection. The term overdraft refers to the completion of a service transaction that results in a balance of resources allocated to a consumer account being less than zero, wherein the allocated resources are monetary resources (e.g., currency, securities, stocks, loans (revolving loans, credit loans, mortgage loans, etc.), or the like) or non-monetary resources (e.g., airtime minutes, data bucket units (bytes, kilobytes, megabytes, gigabytes, terabytes, etc.), bandwidth allocation (e.g., a plurality of frequency carriers), computing time units (e.g., processor-hours or processor resource units), or the like). In an aspect, a service transaction can be a commercial transaction, such as a purchase, a sale, a payment, a debit, a credit, and so forth. In another aspect, a service transaction can be an operational transaction, such as establishment of a wireless call session, a wired call session, a computing job, a memory storage event, or the like, frequency bandwidth consumption event, or the like.

The consumer account is associated with a service such as a financial service (for example, the consumer account is a checking account or a credit line account); a utility service (e.g., the consumer account is a utility billing account); a brokerage service (e.g., the consumer account is a margin brokerage account); a computing service (e.g., the consumer account is a computing time allocation account, or the consumer account is a data storage account); a telecommunication service (e.g., the consumer account is an end-user billing account), and so forth. Such services can supply specific resources that can be allocated (e.g., via an allocation agreement) in an agreed magnitude. The specific resources can be monetary resources (e.g., currency, securities, stocks, loans (revolving loans, credit loans, mortgage loans, etc.), or the like) or non-monetary resources (e.g., airtime minutes, data buckets, bandwidth allocation, computing time units, or the like). As an example of the latter, a utility service can be a prepaid electric power service, wherein the specific resources can be credited electric power (e.g., kW). Overdraft of a service account related to such service can include exceeding an allocation of electric power units (e.g., kW).

An overdraft protection product, and related overdraft protection, can be established (or subscribed) for a service that can supply monetary resources (e.g., currency, securities, stocks, loans (revolving loans, credit loans, mortgage loans, etc.), or the like), non-monetary resources (e.g., airtime minutes or mobile phone minutes, data buckets, bandwidth allocation, computing time units, or the like), or both. Overdraft protection enables a consumer to access resources despite having exceeded an agreed resource allocation. For services that afford monetary resources, the variable service fee is monetary (e.g., an amount of currency). In the alternative, for services that afford non-monetary resources, the variable service fee can be an amount of currency or an amount of non-monetary resources (e.g., airtime minutes or mobile phone minutes).

In exemplary system 100, an overdraft (OD) requestor unit 110 delivers a request 120 for an overdraft transaction, the request 120 having a plurality of data indicative of a service transaction causing the request for the overdraft transaction. It should be appreciated that in certain embodiments, the request can have a single datum indicative of the service transaction causing the request for the overdraft transaction. In one or more embodiments, request 120 can be supplied in accordance with the ISO8583 standard or variations thereof. In an aspect, the service transaction can be a commercial transaction such as an electronic payment transaction having non-sufficient funds to proceed thus triggering the request 120. In certain embodiments, the OD requestor unit 110 is part of issuer processor platform (not shown), which can implement (e.g., process) service transactions, such as the commercial transaction, associated with a service provided to a consumer (an individual, a business, a non-profit organization, etc.). In scenarios in which the commercial transaction is an electronic payment transaction, the issuer processor platform can be a card processor platform that administers payment transactions effected through electronic payment cards. In an aspect, the commercial transaction (not represented in FIG. 1) can be an electronic payment transaction conducted either at a point of sale (POS) terminal or in a web-based commerce interface (e.g., a webpage for conducting electronic payment(s)). In an aspect, the plurality of data indicative of the commercial transaction causing the request for the overdraft transaction comprises data indicative of one or more of a location of a POS terminal, an owner of the POS terminal, an identifier of the POS terminal, a merchant category, a monetary value of the commercial transaction, a type of the commercial transaction, a personal account number (PAN), a security code of a monetary instrument related to, or associated with, the commercial transaction, expiration date of such monetary instrument, or a balance of an account linked to such monetary instrument. In certain embodiments, the monetary instrument related to, or associated with, the commercial transaction can be an electronic payment card. In such embodiments, the security code can be one of card verification value (CVV), a card verification code (CVC), or a CVV2, a CVC2, or a card identification number (CID) in commercial transactions in which the monetary instrument is an electronic payment card that is not present in the transaction (e.g., web-based commerce transactions).

An OD processing platform 130 receives the request 120 determines whether an overdraft transaction can be authorized. OD processing platform 130 includes a decision engine 134 that that can authorize or deny the request 120 for the overdraft transaction based at least on a set of one or more rules applicable to the plurality of data. The set of one or more rules can be associated with and specific to a consumer account linked to a subscriber of an overdraft protection product. In an aspect, some or all of the one or more rules can be selected by the subscriber at the time of subscribing for the OD protection product. Based on at least one rule of the set of the rules applicable to the plurality of data, the decision engine 134 can assess a variable service fee to an overdraft account linked to the overdraft transaction for an authorized overdraft transaction. In addition, for an authorized overdraft transaction, a record of the overdraft transaction can be created and retained as part of transactional data storage 146, a memory element such as a database, a file, a register, etc., functionally coupled to decision engine 134. Such record can include one or more of the variable service fee, at least a portion of the plurality of data, a time stamp for the authorized overdraft transaction, a delinquent date, and a charge-off date. In certain embodiments, a record of a denied overdraft transaction can be created and retained as part of transactional data storage 146. Records of OD transactions that are authorized or denied, and other data in transactional data storage 146 are linked (e.g., in a one-to-one relationship or a many-to-one relationship) with overdraft protection products that are part of the group of OD protection product(s) 142. Such records can produce a historical data related to, or associated with, OD transactions for disparate consumers, types of merchant, types of service transactions and times such transactions occurred, and so forth. Consumer behavior can be gleaned or inferred from such historical data. An overdraft protection product embodies an overdraft account of a consumer. In an aspect, the overdraft protection product comprises an overdraft limit; OD processing platform 130 can decline requests for overdraft transactions associated with an overdraft protection product with an outstanding balance equal or larger than the overdraft limit. An overdraft protection product can be deemed delinquent if any unpaid overdraft transactions exist with a delinquent date prior to a current time. In certain scenarios in which the service transaction is an electronic payment transaction, the delinquent date for an overdraft transaction is the forthcoming payday date of a consumer associated with an electronic card employed for the service transaction. Such delinquent date can be floated to a subsequent payday date in cases in which the forthcoming payday date is within three days, e.g., the delinquency grace threshold for consumers with direct deposit in a consumer account utilized for the electronic payment transaction. In addition, an overdraft protection product can be deemed a charge-off account if any unpaid transactions exist with a charge-off date prior to a current date. Records related to, or associated with, an overdraft protection product can be updated to reflect payment of an outstanding overdraft balance due to an authorized overdraft transaction. In one or more embodiments, decision engine 134 can create such records. In alternative or additional embodiments, report engine 136 can create such records.

To assess the variable service fee, the decision engine 134 can supply data indicative of the variable service fee, e.g., variable fee 150, to the issuer processor platform (not shown) which administers a service account associated with a consumer that conducts the service transaction that triggers the request for an OD transaction. In another aspect, to assess the variable service fee, decision engine 134 can debit such fee from an overdraft account linked to the overdraft transaction. In certain embodiments, decision engine 134 can credit the variable overdraft fee to the overdraft account linked to the overdraft transaction in response to the balance being restored to a surplus within a predetermined period, e.g., 24 hours, 48 hours, 72 hours, one week. In additional or alternative embodiments, decision engine 134 can waive the variable service fee based on at least one of the plurality of data that is part of the request 120 or upon historical data related to, or associated with, previous overdraft transactions. Such historical data can be retained in repository 138, within transactional data storage 146.

The set of one or more rules are part of overdraft logic that can be executed by the decision engine 134 to determine approval or denial of a request (e.g., request 120) for an overdraft transaction. In an aspect, a first rule of the set of rules can establish a condition for an overdraft transaction to be approved. The condition or a state thereof can be determined, at least in part, by one or more of the plurality of data. For example, when a balance of the overdraft account linked to the overdraft transaction is indicative of a deficit that is less than a predetermined limit for the overdraft transaction, the condition can adopt a state indicative of approval of the request for the overdraft transaction. Accordingly, the decision engine 134 can be programmed to authorize the overdraft transaction when such state is achieved. For another example, the condition can adopt a first state that is indicative of approval of the overdraft transaction in response to receiving data in the plurality of data that is indicative of a first merchant. In the alternative, the condition can adopt a second state that is indicative of denial of the overdraft transaction in response to receiving data in the plurality of data that is indicative of a second merchant.

In an aspect, a second rule of the set of rules can define settings of an overdraft transaction, such as a cap limit (e.g., a fixed cap fee) to a variable service fee that can be applied to the overdraft transaction. In another aspect, a third rule of the set of rules can define settings of the overdraft transaction that determine the variable service fee to be a percentage of an overdraft amount associated with the overdraft transaction. Such percentage can be specific to the overdraft transaction and thus customized for at least one of the plurality of data of the request for the OD transaction. The percentage can be a configurable parameter regulated by the operator (e.g., owner, lessor, or administrator) of OD processing platform 130. Accordingly, the percentage can adopt various values, such as 1%, 2%, 3%, 4%, 5%, 6%, 7%, 8%, 9%, 10%, 11%, 12%, 13%, 14%, 15%, and so forth. It should be appreciated that the foregoing series of percentage values is a particular, yet not exclusive, illustration of possible values and other percentage values (e.g., 7.5%) are contemplated. In still another aspect, a fourth rule of the set of rules can define settings of the overdraft transaction that determine the variable service fee to be lesser of a percentage of an overdraft amount associated with the overdraft transaction and a fixed cap fee.

Exemplary system 100 enables a notification service that can convey a variety of information associated with an overdraft transaction. In certain embodiments, the notification service is provided by the operator of OD processing platform as an opt-in service to consumers. In alternative embodiments, the notification service is provided as a default service to consumers and can be opted out. In certain scenarios, a report engine 136 can deliver a notification 160 to a user device 170 associated with the overdraft account linked to the overdraft transaction in response to authorizing the overdraft transaction. In the subject disclosure, user device 170 can be user equipment (e.g., a mobile device, or a wearable device) or customer premises equipment (e.g., a home network server, an appliance such as a television set, or the like). In other scenarios, report engine 136 can deliver the notification 160 to the user device 170. Notification 160 can be embodied in at least one of a short message service (SMS) communication, a multimedia message service (MMS) communication, or an email communication. Notification 160 can include current features of a subscribed overdraft protection product, conditions or terms to avoid overdraft fees, etc. For instance, content of the notification 160 can include a listing of grace periods available to pay outstanding overdraft balances. In the foregoing scenarios, report engine 136 can notify user device 170 nearly simultaneously with authorization of an overdraft transaction or nearly simultaneously with assessment of the variable service related to, or associated with, an authorized overdraft transaction.

For certain services that can be afforded overdraft protection in accordance with aspects of described herein, the notification service enabled, at least in part, by report engine 136 can supplement or complement other notification services (SMS communication delivery of resource balances, available monetary credit to purchase resources, etc.) available to such certain services.

Report engine 136 can communicate with user device 170 via one or more access network(s) (not shown in FIG. 1) which can include wireline or wireless networks. Such access networks can comprise wide area networks (WANs), wireless WANs (WWANs), local area networks (LANs), wireless LANs (WLANs), signaling networks (e.g., SS#7), etc.), and so forth. In addition, such networks can operate in accordance with most any communication protocol.

When compared to conventional overdraft protection, at least one advantage of such notification service is that information related to, associated with, authorization of an OD transaction and details thereof (e.g., balance of the overdraft account, amount of the variable service fee, terms and conditions to credit the variable service fee to the overdraft account, and the like) are provide at substantially the same time that the OD transaction is effected, which can enable a consumer linked to the overdraft account to better manage such overdraft account since the substantial absence of a delay amongst conveying the OD transaction occurred and the time the OD transaction occurred can mitigate further costs (e.g., accrual of variable service fees) associated with an overdraft protection software.

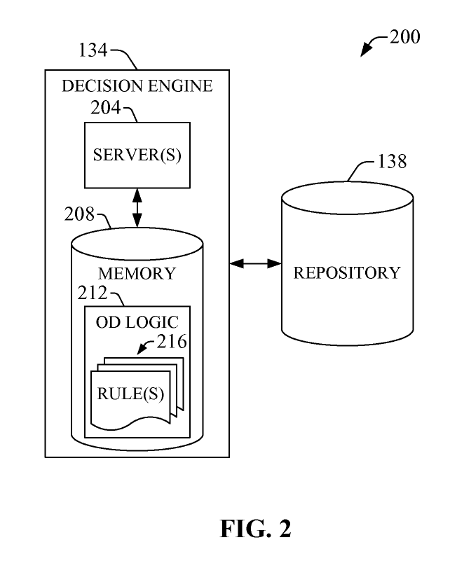

FIG. 2 illustrates an exemplary embodiment 200 of a decision engine 134 in accordance with aspects described herein. In exemplary embodiment 200, server(s) 204 can be configured (e.g., programmed) to execute or can execute OD logic 212 retained in a memory 208. In certain embodiments, server(s) 204 are embodied in a server farm having a plurality of computers (see, e.g., computer 601), wherein each of one of the plurality of computers is programmed to execute OD logic 212. Overdraft logic 212 can include one or more rule(s) 216, wherein at least a portion of the one or more rule(s) 216 can embody the set of one or more rules that are applicable to data related to, or associated with, a request (e.g., request 120) for an OD transaction, and that define, at least in part, a condition for authorizing the OD transaction and features thereof, such as variable service fee cap limit, overdraft limit of an OD protection product, percentage applicable to variable, and other features described herein. Overdraft logic 212 retained, or encoded, in memory 208 can embody a software platform that, in response to execution, cause a processor to perform one or more of the steps of the exemplary methodology described herein.

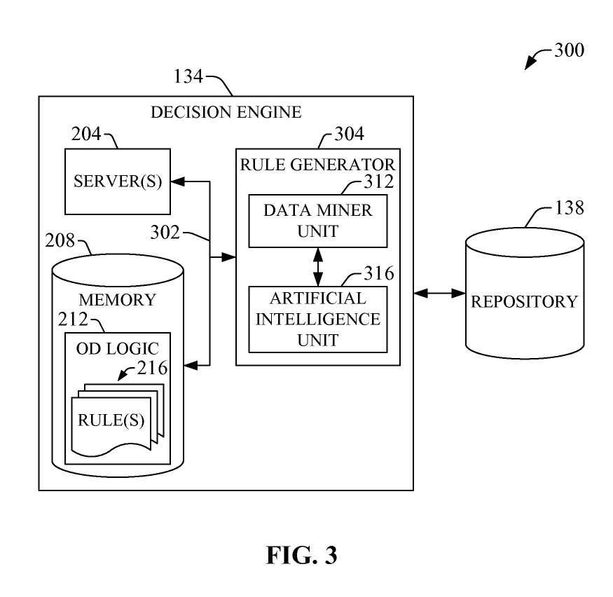

In certain embodiments, the one or more rule(s) 216 can be dynamically adjusted or can be adjusted autonomously based at least on historical data related to, or associated with, overdraft transactions. FIG. 3 illustrates an exemplary system 300 that enables autonomous generation of the set of rules in accordance with aspects described herein. Various functional elements of decision engine 134 are functionally coupled through bus 302, which enables exchange of data, signaling, or any information amongst the various functional elements of decision engine 134. As discussed herein, historical data related to, or associated with, OD transaction can be retained in repository 138 (e.g., a data warehouse) within transactional data storage 146. Rule generator unit 304 (also referred to as rule generator 304) can manipulate at least a portion of the historical data, based on manipulation of such data, extract specific features. In an aspect, rule generator 304 exploits data mining unit 312 to extract specific views or data segments of the historical data. For example, a data segment can include historical data related to, or associated with, OD transactions for a specific merchant type or service provider. For another example, a data segment can include historical data related to, or associated with, OD transactions for a particular group of consumers (young males with issued credit cards, young males with issued credit cards and attending college, tween females with prepaid credit cards, employed adults within a specific tax brackets, etc.). In an aspect, a specific data segment can serve as a data source for rule generator 304, via artificial intelligence unit 316, to extract one or more features of the specific data segment. In certain scenarios, such features can reveal efficiency, such as profitability to an operator of the decision engine 134, of at least one rule of the one or more rule(s) 216. For instance, an elevated delinquency rate in overdraft protection products for young males with issued credit cards and attending college can indicate the at least one rule may have established too high of an overdraft limit or too low of a variable service fee.

In another aspect, in addition to determining efficiency of rules for authorizing or denying OD transactions, or rules for assessing variable service fees, a specific data segment can serve as training data for learning consumer behavior, both statically (e.g., at a specific time slice or instant and for a myriad of locations, merchants, transactions, and so forth) and dynamically (e.g., over a predetermined period). Artificial intelligence unit 316 can implement (e.g., execute) one or more machine learning techniques for learning consumer behavior. Examples of such machine learning techniques include PCA, evolutionary computation (e.g., genetic algorithm), expert systems, case based reasoning, Bayesian networks, behavior based AI, neural networks, fuzzy systems, swarm intelligence (e.g., ant algorithms), and hybrid intelligent systems (e.g., expert inference rules generated through a neural network or production rules from statistical learning). Such techniques can be retained as a group of computer-executable instructions (not shown) in memory 208. As consumer behavior is learned, rule generator 304 can adjust the one or more rule(s) 216 in response to the consumer behavior—since the consumer behavior is learned autonomously, the related adjustment is autonomous. Moreover, as consumer behavior evolves (e.g., due to economic market changes, labor market changes, changes in consumers subscribed to overdraft protection products, or the like) rule generator can autonomously evolve the one or more rule(s) 216 in response. In certain embodiment, in addition to autonomous adjustment of the one or more rule(s) 216 in response to changes in consumer behavior, rule generator 304 also can evaluate efficiency of an evolved rule and refine such rule in order to attain an intended (optimal, nearly-optimal, etc.) level of efficiency.

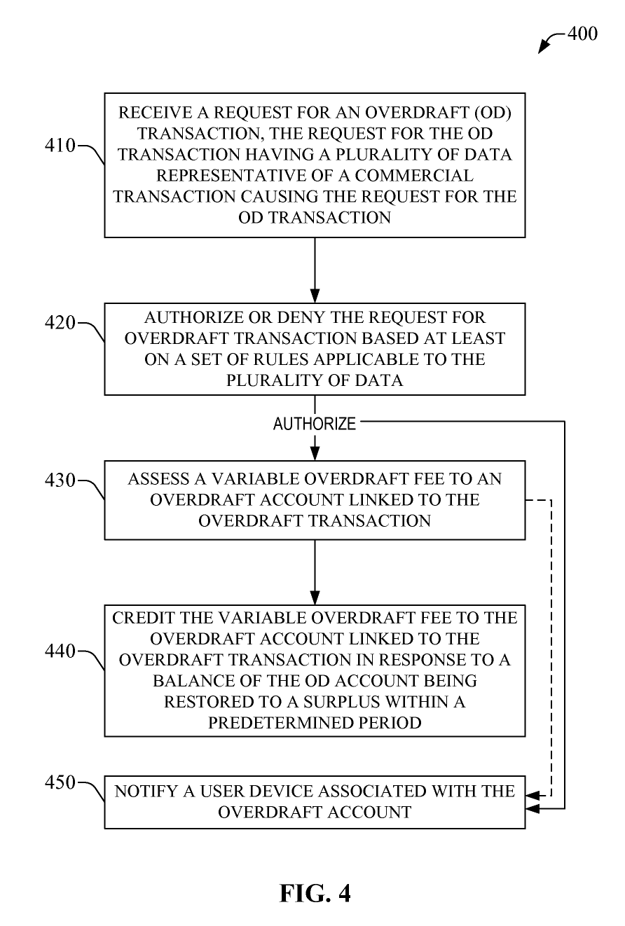

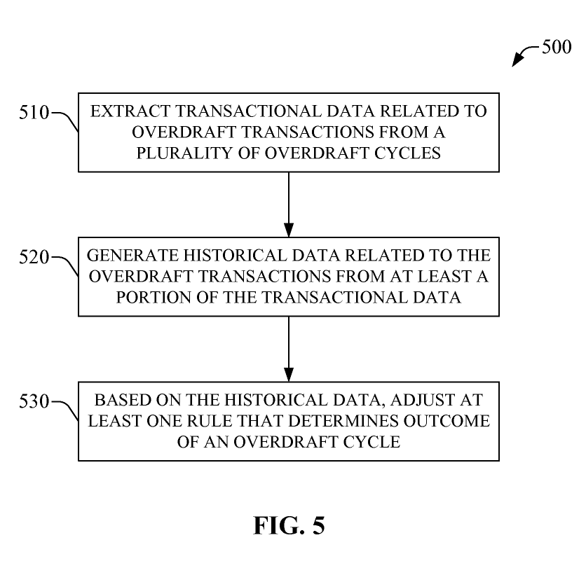

In view of the aspects described hereinbefore, an exemplary method that can be implemented in accordance with the disclosed subject matter can be better appreciated with reference to the flowchart in FIGS. 4-5. For purposes of simplicity of explanation, the exemplary method disclosed herein is presented and described as a series of acts; however, it is to be understood and appreciated that the claimed subject matter is not limited by the order of acts, as some acts may occur in different orders and/or concurrently with other acts from that shown and described herein. For example, the various methods or processes of the subject disclosure can alternatively be represented as a series of interrelated states or events, such as in a state diagram. Moreover, when disparate functional elements implement disparate portions of the methods or processes in the subject disclosure, an interaction diagram or a call flow can represent such methods or processes. Furthermore, not all illustrated acts may be required to implement a method in accordance with the subject disclosure. Further yet, two or more of the disclosed methods or processes can be implemented in combination with each other, to accomplish one or more features or advantages herein described. It should be further appreciated that the exemplary methods disclosed throughout the subject specification can be stored on an article of manufacture, or computer-readable medium, to facilitate transporting and transferring such methods to computers for execution, and thus implementation, by a processor or for storage in a memory.

FIG. 4 is a flowchart of an exemplary method 400 for implementing variable overdraft fees in accordance with aspects of the subject disclosure. As described herein, the variable overdraft fee is part of an overdraft protection product that can be implemented for a variety of services, such as financial services, utility services, brokerage services, computing services, telecommunication services, and so forth. A computing device (e.g., computer 601) that can embody or can comprise the OD processing platform 130 or functional element(s) therein can implement (e.g., execute or perform) the exemplary method 400 or one or more steps thereof. In addition or in the alternative, a processor that is part of or is coupled to the OD processing platform 130 and functional elements therein can implement (e.g., execute or perform) the exemplary method 400 or one or more steps thereof. At step 410, a request for an overdraft (OD) transaction is received, the request for the OD transaction having a plurality of data indicative of a commercial transaction causing the request for the OD transaction. In certain embodiments, the request for OD that is received can have a single datum indicative of such commercial transaction. At step 420, the request for overdraft is authorized or denied based at least on a set of rules (e.g., business rules) applicable to the plurality of data. The subject step 420 is referred to as the authorizing or denying step. In an aspect, the authorizing or denying step comprises authorizing the overdraft transaction when a balance of the overdraft account linked to the overdraft transaction is indicative of a deficit that is less than a predetermined limit for the overdraft transaction. In another aspect, the authorizing or denying step comprises authorizing the overdraft transaction for a first merchant and denying the overdraft transaction for the second merchant.

At step 430, a variable overdraft fee is assessed to an overdraft account linked to the overdraft transaction. Assessing such fee can be based on at least one rule of the set of the rules applicable to the plurality of data. The subject step 430 is referred to as the assessing step. In view of the nature of the services and related consumer accounts that can be afforded overdraft protection, assessing the variable overdraft fee can comprise assessing a fee that is an amount of non-monetary resources (e.g., airtime minutes or mobile phone minutes, data buckets, bandwidth allocations, computing time units, or the like), or assessing a fee that is an amount of a monetary resource (e.g., currency, securities, stocks, loans (revolving loans, credit loans, mortgage loans, etc.), or the like). In an aspect, the assessing step comprises determining the variable overdraft fee to be a percentage of an overdraft amount associated with the overdraft transaction. As described hereinbefore, the percentage can be a configurable parameter regulated by the operator (e.g., owner, lessor, or administrator) of a platform that administers overdrafts products (e.g., the operator of OD processing platform 130). In another aspect, the assessing step can comprise determining the variable overdraft fee to be a fixed cap fee, which can be specific to the overdraft transaction and thus customized for at least one of the plurality of data of the request for the OD transaction. In certain embodiments, the fixed cap fee can be a fee agreed amongst a consumer and the operator of the platform that administers overdrafts products (e.g., the operator of OD processing platform 130). In yet another aspect, the assessing step can comprise determining the variable overdraft fee to be the lesser of a percentage of an overdraft amount associated with the overdraft transaction and a fixed cap fee.

In certain scenarios, the assessing step can comprise waiving the variable service fee based on at least one of the plurality of data. In such scenarios, the at least one rule of the set of the rules applicable to the plurality of data can dictate that the OD transaction is qualified for a waiver of fees and thus assessing the variable overdraft fee results in waiving the variable overdraft fee. At step 450, the variable overdraft fee is credited to the overdraft account linked to the overdraft transaction in response to the balance being restored to a surplus within a predetermined period. As described herein, the predetermined period can be 24 hours, 48 hours, 72 hours, one week, or the like.

In exemplary method 400, in response to authorizing the overdraft transaction, a user device associated with the overdraft account linked to the overdraft transaction is notified at step 450. In an aspect, notifying such user device comprises delivering at least one of a short message service (SMS) communication, a multimedia message service (MMS) communication, or an email communication. As illustrated, such user device is notified nearly simultaneously with the authorizing step that is part of step 420. However, as illustrated with a dashed arrow, in alternative embodiments, such user device can be notified nearly simultaneously with step 430 (referred to as the assessing step).

Collectively, steps 410 through 430 embody an overdraft cycle. A series of two or more overdraft cycles, and data related therewith, can provide historical data that can be exploited to identify consumer behavior in connection with overdraft transactions, and to modify at least one rule of a set of rules that dictate, at least in part, authorization or denial of a request for an OD transaction. Exemplary method 500 depicted in the flowchart of FIG. 5 illustrates adjustment of at least one rule of a set of rules that determines outcome of an overdraft cycle. In an aspect, outcome of the overdraft cycle can include outcome of specific stages (e.g., step 420, step 430) of the overdraft cycle. A computing device (e.g., computer 601) that can embody or can comprise the OD processing platform 130 or functional elements therein can implement (e.g., execute or perform) the exemplary method 500 or one or more steps thereof. In addition or in the alternative, a processor that is part of or is coupled to the OD processing platform 130 and functional elements therein can implement (e.g., execute or perform) the exemplary method 500 or one or more steps thereof. At step 510, transactional data related to, or associated with, overdraft transactions from a plurality of overdraft cycles is extracted. In an embodiment, the plurality of overdraft cycles is a series of instances of steps 410-430. At step 520, historical data related to, or associated with, the overdraft transactions is generated from at least a portion of the transactional data. At step 530, based on the historical data, adjust the at least one rule that determines outcome of the overdraft cycle. In certain embodiments, adjusting the at least one rule comprises adjusting at least one rule of the set of rules applicable to a plurality of data associated with a request for an overdraft transaction, see, e.g., step 410. In an aspect, adjusting the at least one rule that determines outcome of the overdraft cycle includes adjusting one or more rules that determine approval or denial of a request for an overdraft transaction. In another aspect, adjusting the at least one rule for determining outcome of the overdraft cycle includes adjusting one or more rules for determining a variable service fee associated with the overdraft transaction. In yet another aspect, adjusting the at least one rule comprises dynamically defining the at least one rule, wherein the step of dynamically defining the at least one rule includes applying a set of state criteria to time-dependent conditions that define the rules without machine learning. In another aspect, adjusting the at least one rule comprises autonomously defining the at least one rule, wherein the step of autonomously defining the at least one rule comprises applying a genetic algorithm to the set of rules or exploiting other formalisms for machine learning to evolve the set of rules.

As discussed herein, the methods of the subject disclosure can be encoded in a computer-readable storage medium as a group of computer-executable instructions. In an embodiment, one such medium can be a computer-readable non-transitory storage medium comprising a first group of computer-executable instructions that, in response to execution, cause a processor to receive a request for an overdraft transaction, the request for the overdraft transaction having a plurality of data indicative of a commercial transaction causing the request for the overdraft transaction. In certain embodiments, the request for the overdraft transaction can have a single datum indicative of the commercial transaction. The computer-readable non-transitory storage medium also can comprise a second group of computer-executable instructions that, in response to execution, cause the processor to authorize or deny the request for the overdraft transaction based at least on a set of rules applicable to the plurality of data. In addition, the computer-readable non-transitory storage medium can comprise a third group of computer-executable instructions that, in response to execution, cause the processor to assess a variable overdraft fee to an overdraft account linked to the overdraft transaction for an authorized overdraft transaction.

In another aspect, the computer-readable non-transitory storage medium can comprise a fourth set of computer-executable instructions that, in response to execution, cause the processor to extract transactional data related to, or associated with, overdraft transactions from a series of repetitions of steps 410-430. Moreover, the computer-readable non-transitory storage medium can comprise a fifth set of computer-executable instructions that, in response to execution, cause the processor to generate historical data related to, or associated with, the overdraft transactions from the transactional data. Furthermore, the computer-executable non-transitory storage medium can comprise a sixth set of computer-executable instructions that, in response to execution, cause the processor to adjust at least one rule of the set of rules applicable to the plurality of data based at least on the historical data.

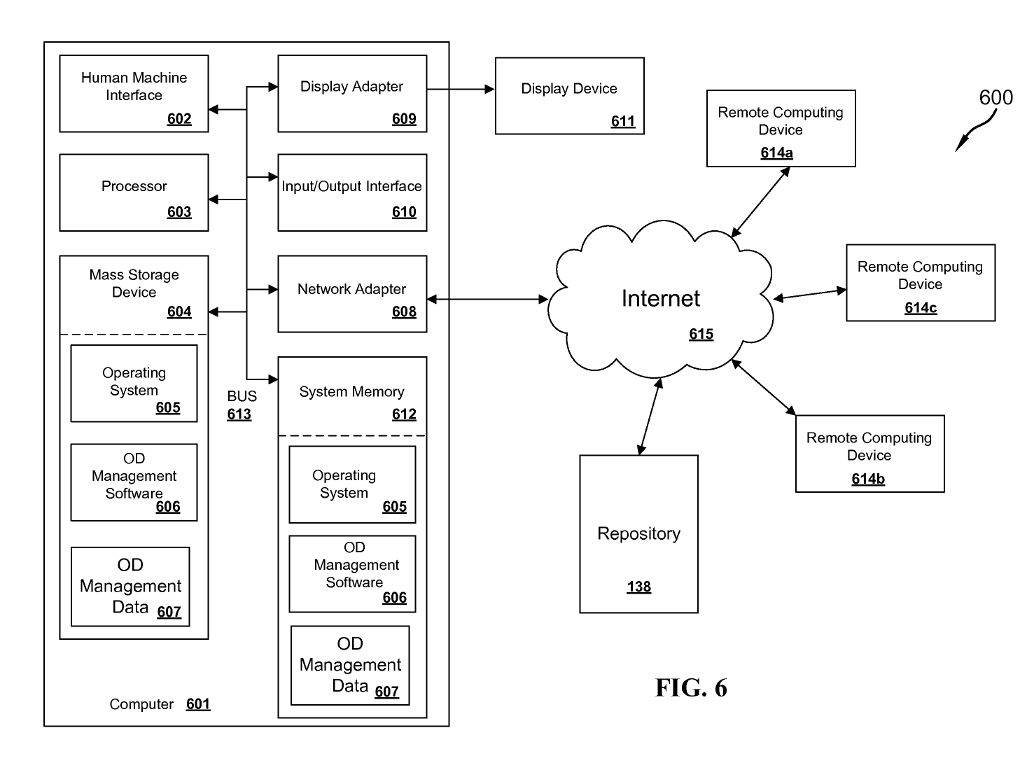

FIG. 6 illustrates a block diagram of an exemplary operating environment 600 that enables various features of the subject disclosure and performance of the various methods disclosed herein. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The various embodiments of the subject disclosure can be operational with numerous other general purpose or special purpose computing system environments or configurations. Examples of well known computing systems, environments, and/or configurations that can be suitable for use with the systems and methods comprise, but are not limited to, personal computers, server computers, laptop devices or handheld devices, and multiprocessor systems. Additional examples comprise wearable devices, mobile devices, set top boxes, programmable consumer electronics, network PCs, minicomputers, mainframe computers, distributed computing environments that comprise any of the above systems or devices, and the like.

The processing effected in the disclosed systems and methods can be performed by software components. The disclosed systems and methods can be described in the general context of computer-executable instructions, such as program modules, being executed by one or more computers or other computing devices. Generally, program modules comprise computer code, routines, programs, objects, components, data structures, etc. that perform particular tasks or implement particular abstract data types. The disclosed methods also can be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 601. The components of the computer 601 can comprise, but are not limited to, one or more processors 603, or processing units 603, a system memory 612, and a system bus 613 (which can embody bus 302) that couples various system components including the processor 603 to the system memory 612. In the case of multiple processing units 603, the system can utilize parallel computing.

In general, a processor 603 or a processing unit 603 refers to any computing processing unit or processing device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally or alternatively, a processor 603 or processing unit 603 can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors or processing units referred to herein can exploit nano-scale architectures such as, molecular and quantum-dot based transistors, switches and gates, in order to optimize space usage or enhance performance of the computing devices that can implement the various aspects of the subject disclosure. Processor 603 or processing unit 603 also can be implemented as a combination of computing processing units.

The system bus 613 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description also can be implemented over a wired or wireless network connection and each of the subsystems, including the processor 603, a mass storage device 604, an operating system 605, OD management software 606, OD management data 607, a network adapter 608, system memory 612, an Input/Output Interface 610, a display adapter 609, a display device 611, and a human machine interface 602, can be contained within one or more remote computing devices 614a,b,c at physically separate locations, connected through buses of this form, in effect implementing a fully distributed system. In an aspect, OD management software code 606 can comprise an OD software platform (e.g., OD logic 234) and rule generator 304 (see, e.g., FIGS. 2-3); such functional elements can be embodied in code instructions and executed by processing unit 603.

The computer 601 typically comprises a variety of computer readable media. Exemplary readable media can be any available media that is accessible by the computer 601 and comprises, for example and not meant to be limiting, both volatile and non-volatile media, removable and non-removable media. The system memory 612 comprises computer readable media in the form of volatile memory, such as random access memory (RAM), and/or non-volatile memory, such as read only memory (ROM). The system memory 612 typically contains data (such as a group of tokens employed for code buffers) and/or program modules such as operating system 605 and OD management software 606 that are immediately accessible to and/or are presently operated on by the processing unit 603. Operating system 605 can comprise OSs such as Windows operating system, Unix, Linux, Symbian, Android, iOS, Chromium, and substantially any operating system for wireless computing devices or tethered computing devices.

In another aspect, the computer 601 also can comprise other removable/non-removable, volatile/non-volatile computer storage media. By way of example, FIG. 6 illustrates a mass storage device 604 which can provide non-volatile storage of computer code, computer readable instructions, data structures, program modules, and other data for the computer 601. For example and not meant to be limiting, a mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 604, including by way of example, an operating system 605, and OD management software 606. Each of the operating system 605 and OD management software 606 (or some combination thereof) can comprise elements of the programming and the OD management software 606. Data and code (e.g., computer-executable instruction(s)) can be retained as part of OD management software 606 and can be stored on the mass storage device 604. Overdraft management software 606, and related data and code, can be stored in any of one or more databases known in the art. Examples of such databases comprise, DB2®, Microsoft® Access, Microsoft® SQL Server, Oracle®, mySQL, PostgreSQL, and the like. Further examples include membase databases and flat file databases. The databases can be centralized or distributed across multiple systems.

In another aspect, the user can enter commands and information into the computer 601 via an input device (not shown). Examples of such input devices comprise, but are not limited to, a camera; a keyboard; a pointing device (e.g., a “mouse”); a microphone; a joystick; a scanner (e.g., barcode scanner); a reader device such as a radiofrequency identification (RFID) readers or magnetic stripe readers; gesture-based input devices such as tactile input devices (e.g., touch screens, gloves and other body coverings or wearable devices), speech recognition devices, or natural interfaces; and the like. These and other input devices can be connected to the processing unit 603 via a human machine interface 602 that is coupled to the system bus 613, but can be connected by other interface and bus structures, such as a parallel port, game port, an IEEE 1394 Port (also known as a Firewire port), a serial port, or a universal serial bus (USB).

In yet another aspect, a display device 611 also can be connected to the system bus 613 via an interface, such as a display adapter 609. It is contemplated that the computer 601 can have more than one display adapter 609 and the computer 601 can have more than one display device 611. For example, a display device can be a monitor, an LCD (Liquid Crystal Display), or a projector. In addition to the display device 611, other output peripheral devices can comprise components such as speakers (not shown) and a printer (not shown) which can be connected to the computer 601 via Input/Output Interface 610. Any step and/or result of the methods can be output in any form to an output device. Such output can be any form of visual representation, including, but not limited to, textual, graphical, animation, audio, tactile, and the like.

The computer 601 can operate in a networked environment using logical connections to one or more remote computing devices 614a,b,c. By way of example, a remote computing device can be a personal computer, portable computer, a mobile telephone, a server, a router, a network computer, a peer device or other common network node, and so on. Logical connections between the computer 601 and a remote computing device 614a,b,c can be made via a local area network (LAN) and a general wide area network (WAN). Such network connections can be through a network adapter 608. A network adapter 608 can be implemented in both wired and wireless environments. Such networking environments are conventional and commonplace in offices, enterprise-wide computer networks, intranets, and the Internet 615. Networking environments generally can be embodied in wireline networks or wireless networks (e.g., cellular networks, such as Third Generation (3G) and Fourth Generation (4G) cellular networks, facility-based networks (femtocell, picocell, Wi-Fi networks, etc.).

As an illustration, application programs and other executable program components such as the operating system 605 are illustrated herein as discrete blocks, although it is recognized that such programs and components reside at various times in different storage components of the computing device 601, and are executed by the data processor(s) of the computer. An implementation of OD management software 606 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer-readable media can comprise “computer storage media,” or “computer-readable storage media,” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

While the systems, devices, apparatuses, protocols, processes, and methods have been described in connection with exemplary embodiments and specific illustrations, it is not intended that the scope be limited to the particular embodiments set forth, as the embodiments herein are intended in all respects to be illustrative rather than restrictive.

Unless otherwise expressly stated, it is in no way intended that any protocol, procedure, process, or method set forth herein be construed as requiring that its acts or steps be performed in a specific order. Accordingly, in the subject specification, where description of a process or method does not actually recite an order to be followed by its acts or steps or it is not otherwise specifically recited in the claims or descriptions of the subject disclosure that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

It will be apparent to those skilled in the art that various modifications and variations can be made in the subject disclosure without departing from the scope or spirit of the subject disclosure. Other embodiments of the subject disclosure will be apparent to those skilled in the art from consideration of the specification and practice of the subject disclosure as disclosed herein. It is intended that the specification and examples be considered as non-limiting illustrations only, with a true scope and spirit of the subject disclosure being indicated by the following claims.

What is claimed is:

1. A method, comprising:
(a) receiving a request for an overdraft transaction, the request for the overdraft transaction having one or more data indicative of a service transaction causing the request for the overdraft transaction;
(b) authorizing or denying the request for the overdraft transaction based at least on a set of rules applicable to the one or more data; and
(c) in response to authorizing the overdraft transaction, assessing a variable overdraft fee to an overdraft account linked to the overdraft transaction, wherein the assessing is based on at least one rule of the set of the rules applicable to the one or more data.

2. The method of claim 1, wherein the authorizing or denying step comprises authorizing the overdraft transaction when a balance of the overdraft account linked to the overdraft transaction is indicative of a deficit that is less than a predetermined limit for the overdraft transaction.

3. The method of claim 1, wherein the authorizing or denying step comprises authorizing the overdraft transaction for a first merchant and denying the overdraft transaction for the second merchant.

4. The method of claim 2, further comprising crediting the variable overdraft fee to the overdraft account linked to the overdraft transaction in response to the balance being restored to a surplus within a predetermined period.

5. The method of claim 1, wherein the assessing step comprises determining the variable overdraft fee to be a percentage of an overdraft amount associated with the overdraft transaction.

6. The method of claim 1, wherein the assessing step comprises determining the variable overdraft fee to be a fixed cap fee.

7. The method of claim 1, wherein the assessing step comprises determining the variable overdraft fee to be lesser of a percentage of an overdraft amount associated with the overdraft transaction and a fixed cap fee.

8. The method of claim 1, wherein the assessing step comprises waiving the variable overdraft fee based on at least one of the one or more data.

9. The method of claim 1, further comprising: in response to authorizing the overdraft transaction, notifying a user device associated with the overdraft account linked to the overdraft transaction, wherein the notifying is performed nearly simultaneously with the authorizing.

10. The method of claim 9, wherein the notifying step comprises delivering at least one of a short message service (SMS) communication, a multimedia message service (MMS) communication, or an email communication.

11. The method of claim 1, further comprising:
extracting transactional data associated with overdraft transactions from a series of repetitions of steps (a)-(c);
generating historical data associated with the overdraft transactions from the transactional data; and
adjusting at least one rule of the set of rules applicable to the one or more data based at least on the historical data.

12. The method of claim 11, wherein the adjusting step comprises autonomously defining the at least one rule.

13. The method of claim 12, wherein the autonomously defining step comprises applying a genetic algorithm to the set of rules.

14. The method of claim 1, wherein the assessing step comprises assessing a fee that is an amount of non-monetary resources including mobile phone minutes, data buckets, bandwidth allocations, or computing time units.

15. The method of claim 1, wherein the assessing step comprises assessing a fee that is an amount of a monetary resource including currency, securities, stocks, or loans.

16. A system, comprising:
a memory that retains data and computer-executable instructions; and
a processor functionally coupled to the memory and programmed by the computer-executable instructions to:
receive a request for an overdraft transaction, the request for the overdraft transaction having one or more data indicative of a service transaction causing the request for the overdraft transaction;
authorize or deny the request for the overdraft transaction based at least on a set of rules applicable to the one or more data; and
based on at least one rule of the set of the rules applicable to the or more data, assess a variable overdraft fee to an overdraft account linked to the overdraft transaction for an authorized overdraft transaction.

17. The system of claim 16, wherein the one or more data indicative of the service transaction causing the request for the overdraft transaction comprises data indicative of one or more of a location of a point of sale (POS) terminal, an owner of the POS terminal, an identifier of the POS terminal, a merchant category, an monetary value of a commercial transaction, a type of the commercial transaction, a personal account number (PAN), a security code of a monetary instrument associated with the commercial transaction, or a balance of an account linked to the monetary instrument associated with the commercial transaction.

18. The system of claim 16, wherein the set of rules are dynamically adjusted or are adjusted autonomously based at least on historical data associated with overdraft transactions.

19. The system of claim 16, wherein the processor is further programmed to authorize the overdraft transaction when a balance of the overdraft account linked to the overdraft transaction is indicative of a deficit that is less than a predetermined limit for the overdraft transaction, the predetermined limit being defined to include the variable overdraft fee.

20. The system of claim 16, wherein the processor is further programmed to authorize the overdraft transaction for a first merchant and to deny the overdraft transaction for the second merchant.

21. The system of claim 19, wherein the processor is further programmed to credit the variable overdraft fee to the overdraft account linked to the overdraft transaction in response to the balance being restored to a surplus within a predetermined period.

22. The system of claim 16, wherein the processor is further programmed to determine the variable overdraft fee to be a percentage of an overdraft amount associated with the overdraft transaction.

23. The system of claim 16, wherein the processor is further programmed to determine the variable overdraft fee to be a fixed cap fee.

24. The system of claim 16, wherein the processor is further programmed to determine the variable overdraft fee to be lesser of a percentage of an overdraft amount associated with the overdraft transaction and a fixed cap fee.

25. The system of claim 16, wherein the processor is programmed to waive the variable overdraft fee based on at least one of the one or more data.

26. The system of claim 16, wherein the variable overdraft fee is one of at least one mobile phone minute, at least one data bucket unit, a bandwidth allocation unit, a computing time unit, a predetermined brokerage fee, a predetermined margin brokerage fee, a currency, a security, a stock, or a loan.

27. A computer program product comprising a computer-readable storage medium encoded with computer-executable instructions comprising:
a first set of computer-executable instructions that, in response to execution, cause a processor to receive a request for an overdraft transaction, the request for the overdraft transaction having one or more data indicative of a service transaction causing the request for the overdraft transaction;
a second set of computer-executable instructions that, in response to execution, cause the processor to authorize or deny the request for the overdraft transaction based at least on a set of rules applicable to the one or more data; and
a third set of computer-executable instructions that, in response to execution, cause the processor to assess a variable overdraft fee to an overdraft account linked to the overdraft transaction for an authorized overdraft transaction.

28. The computer program product of claim 27, wherein the computer-executable instructions further comprise a fourth set of computer-executable instructions that, in response to execution, cause the processor to waive the variable overdraft fee based on at least one of the one or more data.

29. The computer program product of claim 27, wherein the computer-executable instructions further comprise a fifth set of computer-executable instructions that, in response to execution, cause the processor to generate historical data associated with overdraft transactions by reiterating an overdraft cycle.

30. The computer program product of claim 29, wherein the computer-executable instructions further comprise a sixth set of computer-executable instructions that, in response to execution, cause the processor to adjust at least one rule of the set of rules applicable to the one or more data based at least on the historical data.
